(19) United States
(12) Patent Application Publication
(10) Pub. No.: US 2025/0265570 A1
(43) Pub. Date: Aug. 21, 2025

(54) METHODS AND SYSTEMS OF MOBILE PAYMENT AND COUPON AND VOUCHER REDEMPTION

(71) Applicants: Kelly Lu Chen, Plano, TX (US); Bilin Chen, Plano, TX (US)

(72) Inventors: Kelly Lu Chen, Plano, TX (US); Bilin Chen, Plano, TX (US)

(21) Appl. No.: 19/053,534

(22) Filed: Feb. 14, 2025

Related U.S. Application Data
(60) Provisional application No. 63/555,078, filed on Feb. 18, 2024.

(51) Int. Cl. G06Q 20/32; G06Q 20/02; G06Q 30/0207

(52) U.S. Cl. CPC G06Q 20/3276; G06Q 20/027; G06Q 20/3265; G06Q 30/0239

(57) ABSTRACT

The present invention generally relates to systems and methods for executing in-store payments using a third-party mobile wallet. More specifically, the present invention relates to systems and methods for executing in-store mobile payments with coupon and voucher redemptions automatically and in sequence. The invention can also be used in online and telephone-based payment transactions.

### CROSS-REFERENCE TO RELATED APPLICATIONS

The present application is a continuation-in-part of and claims the benefit of priority from U.S. application Ser. No. 17/855,956, Jul. 1, 2022, which is incorporated herein by reference in its entirety and which claims the benefit of priority from U.S. Provisional Application No. 63/217,432, entitled “Methods and Systems of Mobile Payment with Coupon Redemption”, filed on Jul. 1, 2021, which is incorporated herein by reference in its entirety; the application is also a continuation-in-par of and claims the benefit of priority from U.S. application Ser. No. 18/155,753, Jan. 18, 2023, which is incorporated herein by reference in its entirety and which claims the benefit of priority from U.S. Provisional Application No. 63/310,813, entitled “Methods and Systems of Mobile Payment with Voucher Redemption”, filed on Feb. 16, 2022, which is incorporated herein by reference in its entirety; the application is also based on, and claims the benefit of priority from U.S. Provisional Patent Application Ser. No. 63/555,078, filed on Feb. 18, 2024, which is also incorporated herein by reference in its entirety.

### TECHNICAL FIELD

The present invention generally relates to systems and methods for executing in-store payments using a third-party mobile wallet. More specifically, the present invention relates to systems and methods for executing in-store mobile payments with coupon and voucher redemptions automatically and in sequence. The invention can also be used in online and telephone-based payment transactions.

### BACKGROUND OF THE INVENTION

Coupons and vouchers have long been utilized as effective tools for business promotions, both in print and electronic forms. Some coupons are limitedly used to get discounts on certain products, e.g., manufacturer coupons. Some coupons are not defined to use on specific products, but bear some defined monetary values that the holder can redeem as cash on any item. The latter form of coupon is defined as a voucher in this application.

Normally, the merchants redeem coupons and vouchers and take the payments separately and manually at the registers, which can lead to inefficiencies and delays in the checkout process.

Mobile wallet apps like Google Pay and Apple Wallet are increasingly popular, but they lack the capability to handle in-store payments and coupon redemptions simultaneously.

Even though some popular apps have the potential to become mobile wallets, the threshold to adopt near-field communication (NFC), the same technology as Apple Wallet and Google Pay are using, is relatively high. Using QR codes representing payment tokens is a good alternative for those who want to become mobile wallets. The payment token is one of the secure ways to track and transfer payment account information (such as credit card and debit card information).

There are some popular mobile coupon applications, such as RetailMeNot, which are used to show the coupons on the phones to the in-store cashiers. However, under the current payment technology and infrastructure, these applications cannot be used as mobile wallets. Customers have to use different ways to pay for the balances after discounts. Another problem with these coupon applications is that the back-ends of them cannot get the coupon redemption confirmations from the merchants.

A payment gateway used to be a merchant service provided by an e-commerce application service provider that authorizes credit card or debit payments processing for e-businesses and online retailers. But after the POS (point of sale) systems of brick-and-mortar merchants were connected to the internet, the merchants can collect money using payment gateways for their offline businesses. The payment service companies such as Square and Clover are making in-store payments go through their payment gateways. While a typical payment gateway facilitates a payment transaction by transferring information between a payment portal (such as a website or POS) and the front-end processor or acquiring bank, the payment account information, including credit card or debit card information, is the only information which can be transferred to the payment gateways from the payment portals. In a scenario where a third-party mobile wallet (not relative to merchants and payment gateways) wants to use payment tokens to represent the credit card information, there will be no way for the payment gateway to verify the payment token due to the lack of passage to the mobile wallet system in the current infrastructure.

Moreover, for security reasons, the merchants' POS systems are usually not allowed to connect with other third-party systems except the payment gateways.

In summary, even if a third-party mobile wallet finds a way to transfer payment token and coupon information to merchants' POS system, there is no way for them to get the payment token verification request from the payment gateway, or the coupon redemption confirmation from the merchant's POS system. The current payment gateway infrastructure limits the development and application of third-party mobile wallets.

Therefore, there is a need for some new systems and methods that can execute in-store mobile payment with coupon redemption at the same time.

The third-party mobile wallets also need some new infrastructures to get on the road. Correspondingly, payment gateways should also add some new architectures (features and functionalities) to help accomplish coupon redemption and payment automatically and in sequence.

There are a lot of innovations involving mobile payment technologies. Some inventors let the different parts of the ecosystem integrate and infiltrate with each other, but neglect the demand and requirement of security and privacy for some subsystems. For example, the merchants are reluctant to connect their POS and invoicing systems with outside systems, and the merchant systems strictly restrict data exchanges with outside systems. They usually minimum the exchanges, especially, with customers' computing devices, e.g., cell phones. But the merchants' systems are more tending to have data exchanges with payment gateways which connect with merchants' checkout systems in PCI-complying environments.

There are also some scenarios that the merchants need to collect customers' credit card information over the phone, e.g., taking a payment for food delivery order. The lack of security of payment information transmission will impede developments of businesses. Some innovations are needed to solve the problems.

For online shopping, customers usually need to setup a payment account with the ecommerce merchants, or enter the payment card information when checking out. Some customers are reluctant to do those due to security reasons and cumbersomeness. If a mobile wallet can be used for online shopping, that will be very helpful.

### SUMMARY OF THE INVENTION

The problems cited in the background are solved by the present invention.

The instant invention uses an innovative way to accomplish the payment and coupon redemptions simultaneously. The merchants' systems have the least information exchanges with customers' devices. Most of the information, including the coupon information and payment account information, is transferred to merchants' systems from customers' payment account systems via payment gateway systems. The said coupon can be a manufacture coupon, a discount coupon, a voucher bearing some cash value or even a gift card. The coupons involved in the invention are in electronic forms, not paper or other physical forms.

Comprehensively, the inventive methods and systems can also bring the below benefits to merchants, consumers, and some mobile apps' proprietors:
1. The coupon redemption is accomplished with payments automatically and in sequence by the systems; 2. The systems and methods can be used by retail stores and restaurants for instore payments, online order, and even telephone orders, with or without coupon redemptions; 3. Any mobile app with a payment account can be used as a mobile wallet, i.e., the apps of Amazon, Walmart, Chase, Citi, etc., can be used for payment at any merchants' registers or online checkout applications which adopt the inventive methods and systems; 4. The merchants' checkout systems and Sales Invoicing Management Servers are still safely separated from the outside information system. The information exchanged with outside systems is strictly limited. The transaction information is as well-kept as the security of the checkout systems.

The inventive systems mainly include three units: 1. Payment Account System, including Mobile Phone and Payment Account Management Server (PAMS). The PAMS can be owned and managed by some financial institutions, merchants, and e-commerce companies, such as Groupon, Chase, Amazon, and Walmart; 2. Merchant Invoicing System, including Checkout System and Sales Invoicing Management Server (SIMS), which can be owned and managed by some merchants. The checkout system can be for either online or offline shopping. The offline checkout system can be also called a POS (Point of Sale) system. For some small businesses, the offline checkout system can be a cell phone with some relative app installed; In case of online shopping, the checkout system can include a personally-owned computer. 3. Payment Gateway System, which is managed by an online payment service provider. The three units may be owned and managed by different entities. A payment account system is defined as a third-party one when it is owned and managed by an entity independent of those owning and managing the merchant invoicing system and payment gateway system. Each of the three units may be divided into some subsystems. All of the units work together through the relative software.

Before using the arrangement, the customer needs to have a registered payment account saved in some PAMS, and more specifically, have a mobile app associated with the PAMS to initiate the payment and coupon redemption.

If the payment involves a coupon redemption, the customer also needs to add the coupon information to the payment account before initiating the mobile phone payment and coupon redemption.

The customer uses the mobile app to generate a QR code, which includes the payment token (session ID). The QR code is scanned into the checkout system and SIMS during the checkout period, not necessarily after the purchased items are input into the checkout system.

The SIMS sends the payment token and bill balance to the payment gateway system where the payment token is used to identify which PAMS it is issued by. Then the payment token is transferred to the relevant PAMS.

According to the unique payment token, the PAMS matches and finds the initiating payment account, then sends the coupon information (if any) and the payment account information, such as credit card information, to the payment gateway system. In some cases, the credit card information can be replaced by another token authorized by a Token Service Provider (TSP). This token is different from the payment token which is produced and authorized by a PAMS.

Upon receiving the payment account and coupon information (if any), the payment gateway system transfers the coupon information to the merchant invoicing system.

As purchased items are input into the checkout system, the transaction's detailed information, including the item numbers and tag prices, is sent to the merchant's Sales Invoicing Management Server (SIMS) where the information is recorded and saved. In some cases, the item number can be the UPC (Universal Product Code) or SKU (Stock Keeping Unit).

If the coupon includes some SKU or UPC information, the merchant invoicing system will match this information with the bill and deduct the coupon value from the bill. If the coupon is a voucher bearing some monetary value or discount information, the merchant invoicing system will redeem it appropriately.

After redeeming the coupons and finalizing the balance, the SIMS sends the coupon redemption information and final balance to the payment gateway.

After getting the final balance, the payment gateway processes the payment by sending the relative information to the payment processor.

Finally, the payment gateway sends the payment completion notice to the SIMS and PAMS respectively. The payment completion notice may include the coupon redemption information and paid final balance.

By utilizing the inventive arrangement, the consumer can use some mobile apps, such as Chase, Citi, Amazon, Walmart apps, to pay at any merchants' registers or online checkout applications which adopt the inventive systems and methods, whether instore or online, with or without coupon redemptions.

### BRIEF DESCRIPTION OF THE DRAWINGS

The detailed description of the illustrative embodiments can be read in conjunction with the accompanying figures. For simplicity and clarity of illustration, elements illustrated in the figures have not necessarily been drawn to scale.

A clear conception of the advantages and features constituting the present invention, and of the construction and operation of typical mechanisms provided with the present invention, will become more readily apparent by referring to the exemplary, and therefore non-limiting, embodiments illustrated in the drawing accompanying and forming a part of this specification, wherein like reference numerals designate the same elements in the several views, and in which:

FIG. 1 illustrates a functional block diagram depicting systems of mobile payment with or without coupon redemption configured pursuant to some embodiments.

FIG. 2 illustrates an integrated block flowchart depicting the coupon redemption and payment process pursuant to some embodiments.

FIG. 3 illustrates a functional block diagram depicting a payment gateway system configured pursuant to some embodiments.

FIG. 4 illustrates some flow diagrams of some sample user interfaces associated with embodiments of the present invention.

### DETAILED DESCRIPTION OF PREFERRED EMBODIMENTS

A description of embodiments of the present invention will now be given with reference to the figures. It is expected that the present invention may be embodied in other specific forms without departing from its spirit or essential characteristics. The described embodiments are to be considered in all respects only as illustrative and not restrictive.

In describing the preferred embodiment of the invention, which is illustrated in the drawings, specific terminology will be resorted to for the sake of clarity. However, it is not intended that the invention be limited to the specific terms so selected and it is to be understood that each specific term includes all technical equivalents that operate in a similar manner to accomplish a similar purpose.

The systems disclosed herein are used for implementing the methods for performing payment transactions with coupon redemptions. The systems may be a part of an application environment or ecosystem and be designed to perform their intended functions by communicating and interacting with other units and components thereof. The operation of the systems is made possible by integrating hardware, software and electronic communications. Herein, a “unit”, “module”, or “component” is a device, tool, machine or a software program designed to perform a particular task or function.

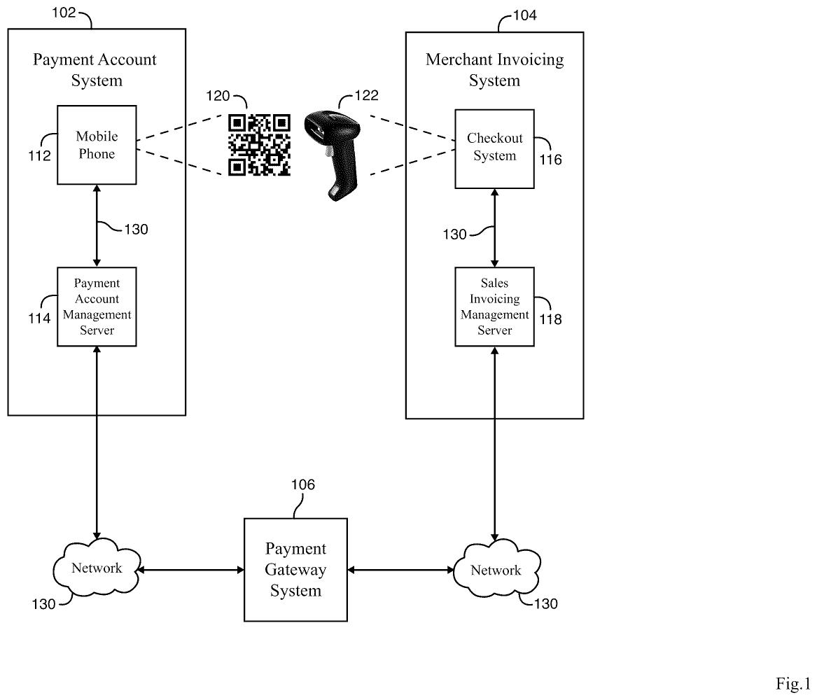

FIG. 1 shows a functional block diagram depicting a system of mobile payments with or without coupon redemptions. The inventive systems mainly include three units: 1. Payment Account System 102, including Mobile Phone 112 and Payment Account Management Server (PAMS) 114. The PAMS 114 can be owned and managed by some e-commerce companies, financial organizations, and merchants, such as Groupon, Chase, Amazon, and Walmart. If a payer or customer uses Amazon or Walmart websites or mobile apps to buy something, his payment account information, such as credit card or debit card information, may have been saved in the PAMS 114. Even though the mobile phone 112 used in the system belongs to payers or customers, there should be a mobile app which is developed by the e-commerce company, financial institution, or merchant installed in the mobile phone 112. The mobile app communicates with PAMS 114 by a network 130, e.g., such as the Internet or other public or private network which can be wired and/or wireless; 2. Merchant Invoicing System 104, including Checkout System 116 and Sales Invoicing Management Server (SIMS) 118, which can be owned and managed by merchants. Checkout System 116 may be located in the stores, preparing invoices for the customer. In case of online shopping, the checkout system 116 can include a personally-owned computer. The SIMS 118 may be remotely arranged. Checkout System 116 can be connected with SIMS 118 by a network 130. The transaction information is collected at the checkout system 116 and stored and managed in SIMS 118; 3. Payment Gateway System 106, which is managed by an online payment service provider; Payment Gateway System 106 communicates with the merchant invoicing system 104 and the payment account system 102 through networks 130. Payment

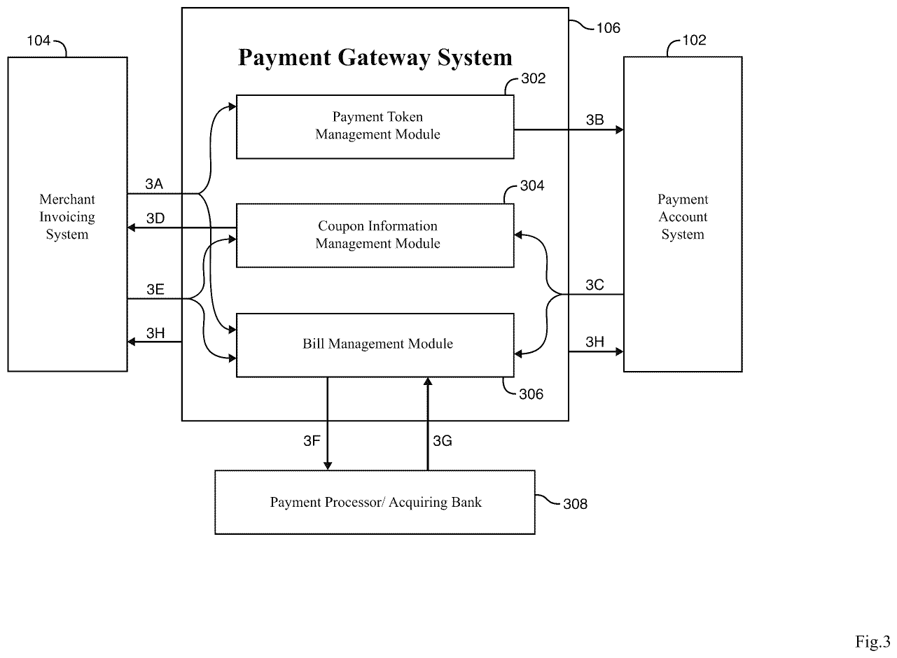

Token Management Modules 302 and Coupon Information Management Modules 304 are added to the innovative payment gateway system 106, which is depicted in FIG. 3 in more detail. The three units may be owned and managed by different entities. Each of the three units may be divided into some subsystems. All of the units work together through the relative software.

FIG. 1 also shows no direct network connection between payment account systems 102 and merchant invoicing systems 104. Due to security reasons, they restrict the information exchanges with other systems, while both of them have internet connections with payment gateway systems 106, usually under PCI (Payment Card Industry) compliance. PCI compliance refers to the technical and operational standards that businesses follow to secure and protect credit card data provided by cardholders and transmitted through card processing transactions. PCI standards for compliance are developed and managed by the PCI Security Standards Council.

FIG. 1 also shows that the merchant invoicing system 104 can get some specific information from the payment account system 102 by scanning a QR code 120 displayed on the customer's mobile phone 112. The scanner 122 is connected to the checkout system 116 and only allows specifically formatted information to be scanned into the system. So, the data input from the scanner 122 won't endanger the merchant invoicing system 104. In case of online shopping, the checkout system 116 can be a personally-owned computer. Then the scanner 122 can be substituted by a camera attached to the computer. For some small businesses, the checkout system 116 and the scanner 122 can be combined into and replaced by a cell phone or a communication device with a camera.

The QR code 120 is actually an imaged data packet. The data packet, which includes a payment token, can also be transmitted from the payment account system 102 to the merchant invoicing system 104 by wireless signals, such as NFC (near-field communication), since there are a lot of mobile phones and checkout systems having NFC capabilities.

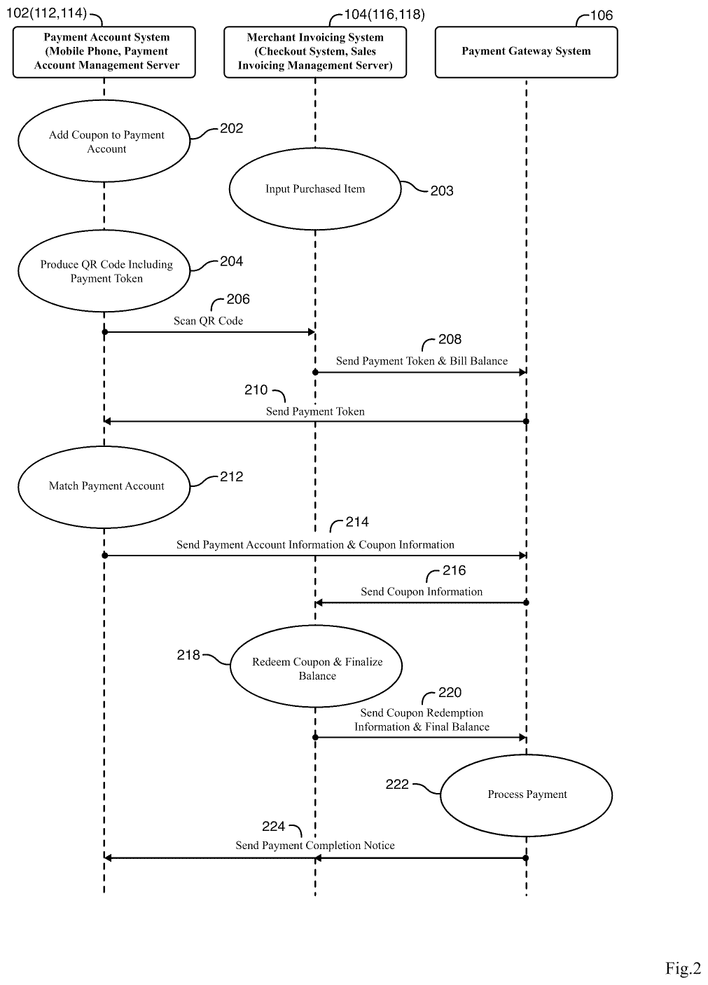

FIG. 2 shows an integrated block flowchart in which the systems and the methods for performing mobile payment with coupon redemption are applied. The integrated block flowchart is similar to the system sequence diagram (SSD), which shows process interactions arranged in time sequence in the field of software engineering. Both of them can depict the processes involved and the sequence of messages exchanged between the processes needed to carry out the functionality.

This kind of diagram specifies and shows the following:
System actors
Messages (methods) invoked by these actors
Return values (if any) associated with previous messages

In FIG. 2, three system actors are shown on the top. The methods are also indicated step by step along the parallel vertical dashed line.

Before using the arrangement, the customer needs to have a registered payment account saved in the payment account system 102, and more specifically, have a mobile phone 112 and a mobile app relative to the payment account management server (PAMS) 114 to initiate the payment and coupon redemption. If a customer is a member of Amazon, his payment account information, like credit card information, should be stored in amazon's PAMS.

At step 202, the customer adds the coupon information into the payment account before launching the mobile phone payment and coupon redemption. If it is a manufacturer coupon, the coupon information may include the merchandise's Uniform Product Code (UPC), discount value and expiration date. It may also only be a string of coupon code which the merchant's checkout system can recognize according to previous arrangements.

At step 204, the customer uses the mobile app to produce a QR code, which includes the payment token (session ID). The payment token mentioned here is actually a session identifier that is a piece of data used in network communication to identify a session, a series of related message exchanges.

At step 206, the QR code is scanned into the merchant invoicing system 104 during the checkout period, not necessarily after the bill is produced in the merchant invoicing system 104 at step 203, as shown in the diagram. The QR code can be scanned into the merchant invoicing system 104 before the bill is produced.

While the purchased items are input into the checkout system 116, the transaction's detailed information, including the item numbers and tag prices, is sent to the merchant's Sales Invoicing Management Server (SIMS) 118 where the information is recorded and stored. In some cases, the item number can be the UPC (Universal Product Code) or SKU (Stock Keeping Unit).

At step 208, the SIMS 118 sends the payment token and bill balance to the payment gateway system 106, where the payment token is used to identify which PAMS it is issued by. The payment token may include an identification code to show which payment account system it is issued by. Then the payment token is transferred to the relevant PAMS 114 at step 210.

According to the unique payment token, the PAMS 114 matches and finds the initiating payment account at step 212, then sends the detailed payment account information, such as credit card information and coupon information, to the payment gateway system 106 at step 214. In some cases, the credit card information can be replaced by another token authorized by a Token Service Provider (TSP). This token is different from the payment token (session ID), which is produced and authorized by a PAMS 114.

After getting the payment account and coupon information, at step 216, the payment gateway system 106 sends the coupon information to the merchant invoicing system 104.

If the coupon is a manufacturer coupon, at step 218, the merchant invoicing system 104 will match the coupon information with the input items, deducts the discount value from the tag price accordingly, and finalizes the invoice balance. If the coupon is a voucher or gift card bearing some monetary value, the merchant invoicing system 104 will validate the coupon and deduct the monetary value from the bill balance.

After redeeming the coupons and finalizing the balance, at step 220, the SIMS 118 sends the coupon redemption information and final balance to the payment gateway system 106.

At step 222, for payment processing, payment gateway system 106 needs to forward the transaction information to the payment processor 308 used by the merchant's acquiring bank following the PCI-compliance regulations and procedures, which are not illustrated in detail in the description of preferred embodiments.

Finally, at step 224, the payment gateway system 106 sends the payment completion notice to SIMS 118 and PAMS 114, respectively. Then the transaction is finished by using the inventive systems and methods of mobile payment with coupon redemption.

FIG. 2 illustrates methods and systems to accomplish the mobile payment with coupon redemption. If there is no coupon redemptions involved, some steps in FIG. 2 could be omitted.

By utilizing the inventive arrangement, the consumer can use some mobile apps, such as Chase, Citi, Amazon, Walmart apps, to pay at any merchants' checkout systems which adopt the inventive systems and methods with or without redeeming coupons. Some mobile coupons apps such as RetailMeNot and Coupons.com can also be used as third parties' mobile wallets to accomplish payment and coupon redemption automatically and in sequence if they establish their own payment account systems.

Also, we can see clearly in FIG. 2, that coupon redemption happens in the merchant invoicing system 104. We know some closed-loop gift cards issued by merchants need to be redeemed at the merchants' checkout system, not at the payment processor's system. So, the said coupon information may include closed-loop gift card information.

FIG. 3 shows a functional block diagram depicting a payment gateway system configured pursuant to some embodiments.

A typical payment gateway system does not include the coupon and payment token management modules. To accomplish the mobile payment with coupon redemption, the invention arranges the additions of coupon information management module 304 and payment token management module 302 into the payment gateway system 106.

At step 3A, a merchant invoicing system 104 sends the payment token and bill balance to the payment gateway system 106, where the two categories of information are respectively filtered into the corresponding modules, which are the payment token management module 302 and the bill management module 306. Two categories of information are managed respectively in the two modules.

In the payment token management module 302, the payment token is used to identify which payment account system 102 it is issued by. The payment token may include an identification code to show which payment account system it is issued by. Then the payment token is transferred to the corresponding payment account system 102 at step 3B.

According to the unique payment token, the payment account system 102 matches and finds the initiating payment account, then sends the detailed payment account information (such as credit card information) and the coupon information (if any) to the payment gateway system 106. The coupon information and payment account information are respectively filtered into the coupon information management module 304 and bill management module 306 in the payment gateway system 106 at step 3C.

At step 3D, the coupon information is transferred to the merchant invoicing system 104, where the coupon is redeemed and the bill balance is finalized.

At step 3E, the coupon redemption information and final balance are sent to payment gateway system 106 and respectively filtered into the coupon information management module 304 and bill management module 306.

After getting the final balance, at step 3F, the bill management module 306 sends the payment account information and the transaction information, including the final bill balance, to the payment processor or acquiring bank 308 for the processing of the payment. Then at step 3G, the payment processor 308 sends the payment confirmation to the bill management module 306.

Finally, at step 3H, the payment gateway system 106 sends the payment confirmation notice to the merchant invoicing system 104 and payment account system 102 respectively. The payment confirmation notice may include the coupon redemption information.

A typical payment gateway facilitates a payment transaction by the transfer of information between a payment portal (merchant invoicing system) and the front-end processor or acquiring bank. In FIG. 3, we can see the inventive payment gateway system 106 is the medium to transfer information among payment account system 102, merchants invoicing system 104, and payment processor 308, which cannot exchange information directly with each other by themselves.

This sophisticated and deliberate system architecture and information flows are made to secure systems and protect against fraud. Additionally, the inventive arrangement subtly accomplishes that a third-party mobile wallet can conveniently pay at any store (online or offline) where the inventive methods and systems are adopted, e.g., Amazon mobile wallet, if any, can be used to pay for in-store and online purchases at Walmart. Without the invention, the customer can only use the merchant's or the payment processor's app, instead of the third-party mobile wallet apps, to make a payment. It is known that a customer can use his PayPal app to pay at CVS stores because PayPal is its payment gateway service provider or payment processor. In this case, the PayPal app cannot be defined as a third-party mobile wallet. Using the inventive infrastructure, even if some mobile wallets are independent of CVS and its payment gateway service provider, CVS's payment gateway system can directly exchange information with third-party payment account systems, such as Amazon, Walmart, and Groupon wallet, if any. The new features and functionalities of the payment gateway system fulfill the third-party mobile payments with or without coupon redemptions.

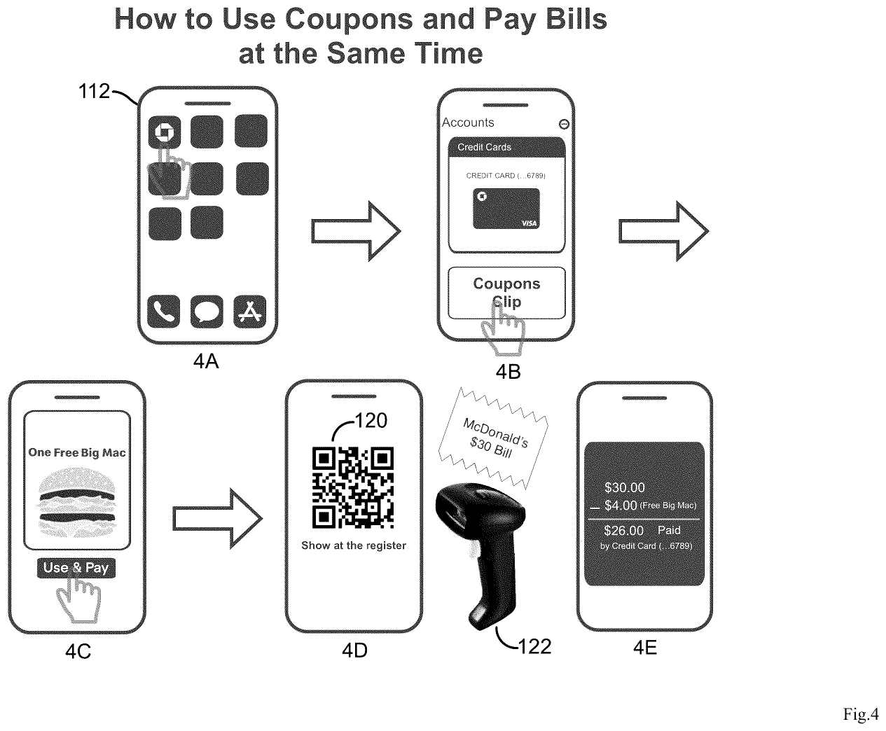

Reference is now made to FIG. 4 which depict a number of illustrative user interfaces that may be presented to a user operating a mobile device (such as the mobile device 112 of FIG. 1) on a display screen of the device so that the customer can conduct payment transactions and coupon redemptions using features of embodiments of the present invention.

It is an interface flowchart illustrating how a customer uses his mobile phone to redeem a coupon and pay a bill simultaneously at a McDonald's store. The fast-food restaurant businesses seriously care about checking efficiency, especially for the driving-through orders. The adoption of this invention at these stores will greatly improve the checking experience of both customers and cashiers.

At step 4A, the customer opens the mobile wallet app by clicking on the icon on the display of the mobile phone 112. The interface at step 4B shows some of the payment account information and the coupons clip icon. In this case, some coupons are already added into the coupon clip. After the customer clicks on the coupon clip icon, the McDonald's coupon information is displayed at step 4C. The customer decided to use the coupon, then click the “Use and Pay” button. Sequentially, at step 4D, a QR code 120 is shown on the display of the phone device. (The QR code in the Figure is only a sample, not a real transaction QR code.) This QR code 120 includes a payment token which the scanner 122 of McDonald's checkout system can read into the merchant invoicing system. Finally, after the transaction payment processing is executed by the payment gateway and payment processor, the coupon redemption and payment confirmation notice are sent back and displayed on the mobile device at step 4E.

Although the present invention has been described in conjunction with specific exemplary embodiments, it should be acknowledged that various changes, substitutions, and alterations apparent to those skilled in the art can be made to the disclosed embodiment without departing from the spirit and scope of the invention as forth in the appended claims.

For example, the QR code utilized in the disclosure is one of the ways to transfer the relative information. Any patterned image that can be read into data by a scanner may be an alternative to replace the QR code. Near-field communication (NFC) and other wireless signals can also transmit information for the inventive systems and methods. The substitution of the data transmission of QR code won't invalid the novelty and creativity of the invention.

It is intended that the appended claims cover all such additions, modifications, and rearrangements.

What is claimed is:

1. A method for operating a payment account system to execute mobile payments, in collaboration with a payment gateway system and a merchant invoicing system, the method comprising:
Producing a data packet, including a payment token (session ID), associated with a payment account;
Transmitting, to said merchant invoicing system, said data packet including said payment token;
Receiving, from said payment gateway system, information including said payment token;
Matching said payment account according to said payment token;
Transmitting, to said payment gateway system, information including said payment account information; and
Receiving, from said payment gateway system, information including a payment completion notice.

2. The method of claim 1, for operating a payment account system to execute mobile payments with coupon redemptions, the method comprising:
Transmitting, to said payment gateway system, information including said payment account information and at least one piece of coupon information, instead of transmitting, to said payment gateway system, information including said payment account information.

3. The method of claim 1, wherein said data packet is shown as an encoded image including at least one of (a) a barcode, (b) a QR code, and (c) an image pattern, the implicit information in said encoded image including said payment token is transmitted to said merchant invoicing system by scanning said encoded image using a scanner or digital camera connected to said merchant invoicing system.

4. The method of claim 1, wherein said data packet is transmitted to said merchant invoicing system by wireless signal.

5. The method of claim 2, wherein said coupon information is closed-loop gift card information, which is redeemed at said merchant invoicing system.

6. The method of claim 2, wherein said payment gateway system is divided into some subsystems including coupon information management module, payment token (session ID) management module and bill management module; thereby, said information is exchanged between said payment account system and said modules.

7. The method of claim 1, wherein said payment account system, operable to executing mobile payments, in collaboration with a payment gateway system and a merchant invoicing system, the payment account system comprising:
a mobile phone;
a payment account management server;
and software programs, wherein the programs are configured to be executed by the mobile phone and payment account management server, the programs including:
Instructions for producing a data packet, including a payment token (session ID), associated with a payment account;
Instructions for transmitting, to said merchant invoicing system, said data packet including said payment token;
Instructions for receiving, from said payment gateway system, information including said payment token;
Instructions for matching said payment account according to said payment token;
Instructions for transmitting, to said payment gateway system, information including said payment account information; and
Instructions for receiving, from said payment gateway system, information including a payment completion notice.

8. A merchant invoicing system, operable to executing mobile payments with coupon redemptions, in collaboration with a payment account system and a payment gateway system, the merchant invoicing comprising:
a checkout system;
a sales invoicing management server;
and software programs, wherein the programs are configured to be executed by the checkout system and sales invoicing management server, the programs including:
Instructions for receiving, from said payment account system, a data packet including a payment token (session ID);
Instructions for transmitting, to said payment gateway system, information including said payment token and an invoice balance;
Instructions for receiving, from said payment gateway system, information including at least one piece of coupon information;
Instructions for redeeming said coupon and finalizing said invoice balance;
Instructions for transmitting, to said payment gateway system, information including said coupon redemption information and final invoice balance; and
Instructions for receiving, from said payment gateway system, information including said payment completion notice.

9. The merchant invoicing system of claim 8, wherein said checkout system is a computer installed with relative software.

10. The merchant invoicing system of claim 8, wherein said data packet is received from said payment account system by wireless signal.

11. The merchant invoicing system of claim 8, wherein said data packet is shown as an encoded image including at least one of (a) a barcode, (b) a QR code, and (c) an image pattern, the implicit information in said encoded image including said payment token is received from said payment account system by scanning said encoded image using a scanner or digital camera connected to said merchant invoicing system.

12. The merchant invoicing system of claim 8, wherein said coupon information is closed-loop gift card information.

13. A method for operating a payment gateway system to execute mobile payments with coupon redemptions, in collaboration with a payment account system and a merchant invoicing system, the method comprising:
Receiving, from said merchant invoicing system, information including a payment token (session ID) and an invoice balance;
Identifying said payment account system according to said payment token;
Transmitting, to said payment account system, information including said payment token;
Receiving, from said payment account system, information including a payment account information and at least one piece of coupon information;
Sending, to said merchant invoicing system, information including said coupon information;
Receiving, from said merchant invoicing system, information including coupon redemption information and said invoice's final balance;
Processing a payment according to information including said payment account information and said invoice's final balance; and
Transmitting, to said payment account system and said merchant invoicing system, information including a payment completion notice.

14. The method of claim 13, wherein said payment token (session ID) includes an identification code which can be used to identify said payment account system.

15. The method of claim 13, wherein said coupon information is closed-loop gift card information.

16. The methods of claim 13, wherein said payment gateway system is divided into some subsystems including a payment token management module, a coupon information management module, and a bill management module; thereby, said information is exchanged between said modules and said merchant invoicing system or said payment account system.

17. A payment gateway system, operable to executing mobile payments with coupon redemptions, in collaboration with a merchant invoicing system and a payment account system, the payment gateway system comprising:
a communication port;
a processor;
a memory;
and software programs, wherein the programs are stored in the memory and configured to be executed by the processor, the programs including:
Instructions for receiving, from said merchant invoicing system, information including a payment token (session ID) and an invoice balance;
Instructions for identifying said payment account system according to said payment token;
Instructions for transmitting, to said payment account system, information including said payment token;
Instructions for receiving, from said payment account system, information including a payment account information and at least one piece of coupon information;
Instructions for sending, to said merchant invoicing system, information including said coupon information;
Instructions for receiving, from said merchant invoicing system, information including coupon redemption information and said invoice's final balance;
Instructions for processing a payment according to information including said payment account information and said invoice's final balance; and
Instructions for transmitting, to said payment account system and said merchant invoicing system, information including a payment completion notice.

18. The payment gateway system of claim 17, wherein said payment token (session ID) includes an identification code which can be used to identify said payment account system.

19. The payment gateway system of claim 17, wherein said coupon information is closed-loop gift card information.

20. The payment gateway system of claim 17, wherein said payment gateway system is divided into some subsystems, including a payment token management module, a coupon information management module, and a bill management module; thereby, said information is exchanged between said modules and said merchant invoicing system or said payment account system.
